(19) United States
(12) Patent Application Publication
(10) Pub. No.: US 2013/0280630 A1
(43) Pub. Date: Oct. 24, 2013

(54) Fuel Cell Electricity Production Device and Associated Startup Method

(71) Applicant: Air Liquide, Societe Anonyme pour Etude et Exploitation des Procedes Georges Claude, (US)

(72) Inventors: Julien MARTEAU, Grenoble (FR); Amaud CERCEAU, Charavines (FR); Xavier ROUSSIN-BOUCHARD, Meaudre (FR)

(21) Appl. No.: 13/650,383

(22) Filed: Oct. 12, 2012

(30) Foreign Application Priority Data
Oct. 14, 2011 (FR) 1159290

(51) Int. Cl. H01M 8/04

(52) U.S. Cl. CPC H01M 8/0432; H01M 8/04014; H01M 8/04067
USPC 429/429; 429/433; 429/436

(57) ABSTRACT

An enclosure houses a fuel cell and defines an enclosed volume around the cell and is provided with openings selectively closed off by mobile shutters for regulate of air circulation between the enclosure interior and exterior, the cell being placed in the enclosure on a support floor, wherein the device comprises at least one selective heating member, separate from the cell, placed in the enclosure underneath the floor, and a volume situated under the floor housing the at least one heating member communicates with the volume of the enclosure situated above the floor via at least one passage.

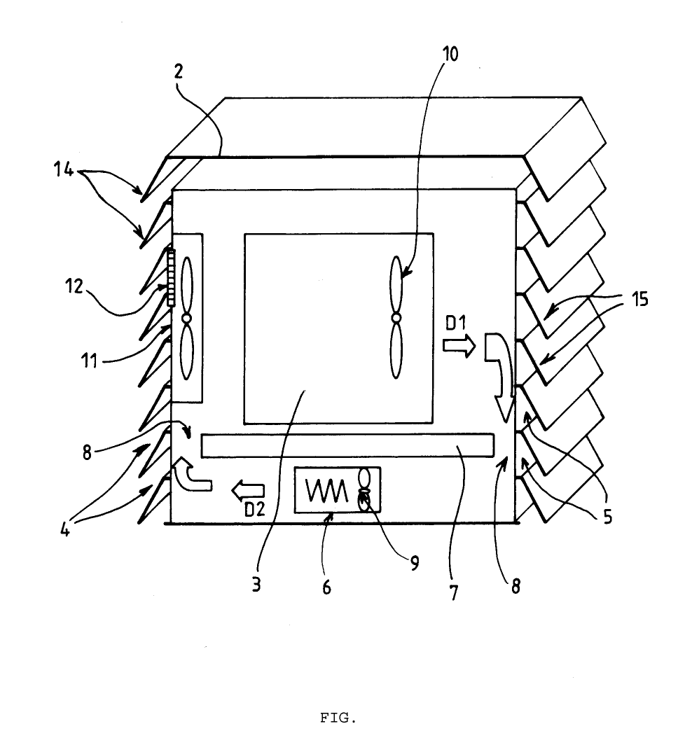

### CROSS-REFERENCE TO RELATED APPLICATIONS

This application claims the benefit of priority under 35 U.S.C. §119 (a) and (b) to French Patent Application No. 1159290, filed Oct. 14, 2011, the entire contents of which are incorporated herein by reference.

### BACKGROUND

1. Field of the Invention

The present invention relates to a fuel cell electricity production device and to the associated startup method.

The invention relates more particularly to a device for producing electricity comprising an enclosure housing within it a fuel cell, notably of the proton exchange membrane type, the enclosure defining an enclosed volume around the cell and being provided with openings that can be selectively closed off by mobile shutters in order to regulate the circulation of air between the inside of the enclosure and the outside, the cell being placed in the enclosure on a support floor.

2. Related Art

In order to operate correctly, a fuel cell needs in a controlled way to remove the heat energy it produces. Known systems use a system in which the cell is air-cooled. The cell has therefore to be configured to accommodate a circulation of air that allows for the accommodation of fresh air and for removal of hot air.

During cell startup phases following storage at negative ambient temperatures, it is sometimes necessary to heat the cell in order to defrost it.

Various documents describe systems for the management of the ambient air around the cell. Document WO08038032 describes an open cathode cell placed in an enclosure and in which the gas leaving the cathode can be recirculated around the enclosure by selectively closing an air outlet of the enclosure.

Document WO0171842 describes a fuel cell placed in a casing supplied with pressurized air via a compressor. Systems of valves allow the air to be recirculated in the casing and, where appropriate, its heat to be extracted via an exchanger.

These known systems where appropriate allow satisfactory management of the ambient temperature around the cell when it is in operation but these systems are not very well, if at all, suited to the startup of a fuel cell in a very cold environment. In addition, in these known systems, the control over the cooling or heating of the ambient surroundings around the cell while it is in operation is not entirely satisfactory. Specifically, the effectiveness of the heating is obtained at the expense of the effectiveness of the cooling, and vice versa.

### SUMMARY OF THE INVENTION

One object of the present invention is to alleviate all or some of the prior art disadvantages noted hereinabove.

To this end, the device according to invention, in other respects in accordance with the generic definition thereof given in the above preamble, is essentially characterized in that the device comprises at least one selective heating member, separate from the cell, placed in the enclosure underneath the floor, and in that the volume situated under the floor housing the at least one heating member communicates with the volume of the enclosure situated above the floor via at least one passage.

Moreover, certain embodiments of the invention may include one or more of the following features:
the device comprises a lower fan placed under the floor, the lower fan being associated with the heating member situated under the floor in order selectively to generate a forced circulation of air between the volume situated under the floor and the volume situated above the floor,
the cell comprises an in-built cooling system equipped with at least one cooling fan, and the at least one cell cooling fan displaces the air above the floor in a first direction,
the lower fan placed under the floor is oriented in such a way as to displace the air in a second direction, opposite to the first direction so as to create a looped flow in the enclosure in which the lower fan draws in air from the delivery side of the at least one cell cooling fan,
the enclosure comprises openings that can be selectively closed off by mobile shutters, the openings being situated on two opposite walls of the enclosure above the floor,
the enclosure comprises openings that can be selectively closed off by mobile shutters, the openings being situated on two adjacent walls of the enclosure above the floor,
the two opposite faces of the enclosure that are provided with the openings that can be closed off are perpendicular to the first direction,
the enclosure comprises at least one upper fan positioned above the floor adjacent to the at least one opening that can be selectively closed off by shutters,
the direction of air flow generated by the at least one cell cooling fan is the same as the direction of air flow generated by the at least one upper fan,
the openings that can be selectively closed off are fitted with particle filters to prevent or limit the ingress of dust into the enclosure,
the floor is a good conductor of heat and notably made of metal,
the dimensions of the floor are smaller than the transverse dimensions of the enclosure which means that the at least one passage providing communication between the volume situated under the floor and the volume of the enclosure situated above the floor comprises spaces between the floor and at least one of the walls of the enclosure,
the floor is slidably mounted in the enclosure, the enclosure having a lateral door forming one of the walls of the enclosure.

The invention also relates to a startup method for a device for producing electricity according to any one of the features listed above or below in the event of a negative temperature, the method comprising a step of closing the openings of the enclosure while the cell is shut down and, before the cell is started up, a step of preheating the air in the enclosure using the at least one heating member.

According to another possible particular feature, when the temperature within the enclosure reaches a set threshold, the cell is brought into operation and the openings of the enclosure are selectively opened.

The invention may also relate to any alternative device or method comprising any combination of the features above or below.

### BRIEF DESCRIPTION OF THE FIGURES

Other specifics and advantages will become apparent from reading the following description, given with reference to the single FIGURE.

The FIGURE is a schematic, partial depiction of the structure and operation of one possible embodiment according to the invention.

### DETAILED DESCRIPTION OF THE INVENTION

The electricity production device depicted in the FIGURE comprises an enclosure 2 housing within it a fuel cell 3. The enclosure 2 is, for example, a compartment of a cabinet of parallelepipedal shape. Another compartment of the cabinet (not depicted) may for example contain electric circuitry or an application (telephony device) intended to be electrically powered by the fuel cell 3.

In the conventional way, the cell 3 is, for example, a cell of the proton exchange membrane type, consisting of a stack of elementary cells. For preference, the cell 3 in the conventional way comprises an in-built cooling system equipped with at least one cooling fan 10. The cell 3 cooling fan 10 displaces the air above the floor 7 in order notably to cool the stack of cells in a first direction D1, for example parallel to the plane of the floor 7.

The enclosure 2 defines an enclosed volume around the cell 3. For the sake of simplicity, the front face of the enclosure 2 has not been depicted in the FIGURE, this front face may for example consist of a hinged door providing access to the inside of the enclosure 2.

The enclosure 2 is provided with openings 4, 5 that can be selectively closed off by shutters 14, 15, for example motorized shutters, in order to regulate the flow of air between the inside of the enclosure 2 and the outside.

The cell 3 rests on a supporting floor 7 in the enclosure 2. The floor 7 is, for example, a parallelepipedal plate slidably mounted in the enclosure 2. The floor 7 is, for example, mounted on slideways so that the cell 3 can be drawn out or pushed in in the manner of a drawer. When the enclosure 2 is placed on a flat horizontal surface the floor 7 is, for example, also horizontal.

The floor 7 delimits volumes situated respectively above and below the floor 7. According to one specific feature, at least one selective air heating member 6, separate from the cell 3, is placed in the enclosure 2, underneath the floor 7. This heating member 6 may for example comprise an electric resistive element or any other appropriate appliance. The volume situated under the floor 7 housing the heating member 6 communicates with the volume of the enclosure 2 situated above the floor 7 via at least one passage 8. For example, the dimensions of the floor 7 are smaller than the transverse dimensions of the enclosure 2 so that the at least one passage 8 is formed of a space between the periphery of the floor 7 and one or more adjacent walls of the enclosure 2. As an alternative or in combination, the passages 8 may comprise openings formed through the floor 7 itself.

With such an arrangement, the air heated by the heating member 6 will naturally rise in the enclosure 2.

In addition, in the event of a fuel that is flammable (gaseous hydrogen fed to the cell 3), the hydrogen will also migrate towards the top of the enclosure 2 and therefore avoid contact with the hot part of the heating member 6 situated under the floor 7. For that reason, a hydrogen detection sensor may notably be positioned in the upper part of the enclosure in order to detect any leak that might arise.

The floor 7 is preferably a good conductor of heat and notably made of metal. Thus, the floor 7 also constitutes a dissipater of heat (the floor 7 is heated by the heating positioned underneath it).

For preference, a lower fan 9 is positioned under the floor 7. This lower fan 9 is associated with the heating member 6 situated under the floor 7 in order selectively to generate a forced flow of hot air from the volume situated under the floor 7 towards the volume situated above the floor 7.

For preference, the lower fan 9 is oriented in such a way as to displace the air in a second direction D2, the main component of which is the opposite of the first direction D1. For example, the lower fan 9 is oriented to displace the air in a direction parallel to the plane of the floor 7 but in the opposite direction to the cell 3 cooling fan 10. In this way, the creation of a looped flow of gas in the enclosure 2 around the floor 7 is encouraged (as schematically depicted by the arrows in the FIGURE). Thus, the lower fan 9 draws in downwards air that has come from the delivery side of the at least one cell cooling fan 10 and dispatches it back towards the top of the enclosure 2.

That creates forced convection which combines with the natural convection so that the entire enclosure 2 is swept with hot air.

As depicted, for preference the openings 4, 5 which can be selectively closed off by mobile shutters 14, 15 are situated on two opposite walls of the enclosure 2. In the example depicted in the FIGURE, the openings 4, 5 are formed over the entirety of the walls concerned. However, in a preferred embodiment, these closable openings 4, 5 are situated only above the plane of the floor 7. Likewise, in one possible and optional embodiment, the openings 4, 5 that can be selectively closed off by mobile shutters 14, 15 may be situated on two perpendicular walls of the enclosure 2 (notably on two adjacent walls of the enclosure 2). Specifically, this alternative form, although it is not preferred because it could potentially increase the pressure drop in the air flow, may become necessary because of other integration constraints.

The two opposite faces of the enclosure 2 which are provided with the closable openings 4, 5 are, for example, perpendicular to the first direction D1.

In addition, the enclosure 2 may comprise at least one upper fan 11 positioned above the floor 7 adjacent to at least one opening 4, 5 that can be selectively closed off by shutters. The cooling fan or fans 10 are, for example, placed inside the enclosure 2, behind the openings 4, 5 of one of the walls of the enclosure 2.

Thus, the direction of the air flow generated by the at least one upper fan 11 may be the same as the first direction D1 of air flow generated by the at least one cell 3 cooling fan 10. This further encourages the cooling heat exchanges as necessary.

Specifically, having the cell 3 confined within the enclosure 2, which is of benefit for thermally insulating the cell 3 and protecting it from environmental pollution (dust), generates pressure drops which reduce the potential flow rate of air dedicated to the cooling. This or these upper fans 11, placed in series with the cell 3 cooling fan or fans 10 make it possible to make up for any deficit in cooling.

This or these upper fan or fans 11 can be used selectively to supplement the cooling of the cell 3.

As indicated schematically in the FIGURE, at least some of the openings 4, 5 that can be selectively closed off may be fitted with filters 12 to prevent or limit the ingress of dust into the enclosure 2.

It will therefore be appreciated that, while being of a simple structure, the device allows the cell 3 to be confined when this cell is shut down in order to maintain good insulation for the pre-startup heating phase.

Specifically, in order to start up the device in the event of a negative temperature, provision may be made for the openings 4, 5 of the enclosure 2 to be closed as long as the cell 3 is shut down. Before the cell 3 is started up, the enclosure may be heated via the at least one heating member 6. This configuration means that cell startup is conceivable even when the enclosure is in a very negative environment (−20° C.).

When the temperature within the enclosure 2] reaches a set threshold, the cell 3 can be brought into operation and the openings 4, 5 of the enclosure 2 are selectively opened and the upper fan or fans 11 are activated to cool the cell 3 if need be (if the cell cooling fan or fans 10 will not suffice).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A device for producing electricity comprising an enclosure housing within it a fuel cell, the enclosure defining an enclosed volume around the cell and being provided with openings that can be selectively closed off by mobile shutters in order to regulate circulation of air between an inside of the enclosure and an outside of the enclosure, the cell being placed in the enclosure on a support floor, characterized in that the device comprises at least one selective heating member, separate from the cell, placed in the enclosure underneath the floor, and in that a volume situated under the floor housing the at least one heating member communicates with a volume of the enclosure situated above the floor via at least one passage.

2. The device of claim 1, further comprising a lower fan placed under the floor, the lower fan being associated with the heating member situated under the floor in order to selectively generate a forced circulation of air between the volume situated under the floor and the volume situated above the floor.

3. The device of claim 2, wherein:
the cell comprises a built-in cooling system equipped with at least one cooling fan; and
the at least one cell cooling fan displaces the air above the floor in a first direction.

4. The device of claim 3, wherein the lower fan placed under the floor is oriented in such a way as to displace the air in a second direction, opposite to the first direction so as to create a looped flow in the enclosure in which the lower fan draws in air from the delivery side of the at least one cell cooling fan.

5. The device of claim 3, wherein:
the enclosure further comprises at least one upper fan positioned above the floor adjacent to the at least one opening that can be selectively closed off by shutters; and
the direction of air flow generated by the at least one cell cooling fan is the same as the direction of air flow generated by the at least one upper fan.

6. The device of claim 1, wherein the enclosure comprises openings that can be selectively closed off by mobile shutters, the openings being situated on two opposite walls of the enclosure above the floor.

7. The device of claim 6, wherein the two opposite faces of the enclosure that are provided with the openings that can be closed off are perpendicular to the first direction.

8. The device of claim 1, wherein the enclosure comprises at least one upper fan positioned above the floor adjacent to the at least one opening that can be selectively closed off by shutters.

9. The device of claim 1, wherein the openings that can be selectively closed off are fitted with particle filters to prevent or limit the ingress of dust into the enclosure.

10. The device of claim 1, wherein the floor is a heat conductor and is made of metal.

11. The device of claim 1, wherein the fuel cell is of the proton exchange membrane type.

12. A startup method for the device for producing electricity according to claim 1 in the event of a negative temperature, said method comprising the steps of:
closing the openings of the enclosure while the cell is shut down; and
before the cell is started up, preheating the air in the enclosure using the at least one heating member.

13. The method of claim 12, wherein, when the temperature within the enclosure reaches a set threshold, the cell is brought into operation and the openings of the enclosure are selectively opened.
